(19) United States
(12) Patent Application Publication
(10) Pub. No.: US 2006/0049758 A1
(43) Pub. Date: Mar. 9, 2006

(54) Plasma display panel

(76) Inventor: Woong Kee Min, (US)

Correspondence Address: Song K. Jung;MCKENNA LONG & ALDRIDGE LLP, 1900 K Street, N.W., Washington, DC, 20006, US

(21) Appl. No.: 11/217,730

(22) Filed: Sep. 2, 2005

(30) Foreign Application Priority Data
Sep. 6, 2004 (KR) 10-2004-0071009

(51) Int. Cl. H01J 17/49

(52) U.S. Cl. 313/582

(57) ABSTRACT

The present invention relates to a Plasma Display Panel (PDP). The PDP according to the present invention includes first barrier ribs for partitioning a plurality of sub-pixels, and second barrier ribs for partitioning adjacent unit pixels with the plurality of sub-pixels forming one unit pixel. In this case, the width of the second barrier ribs partitioning the unit pixels is wider than that of the first barrier ribs partitioning the plurality of sub-pixels, and a sub-pixel located at the center among the plurality of sub-pixels is a blue sub-pixel.

### CROSS-REFERENCES TO RELATED APPLICATIONS

This Nonprovisional application claims priority under 35 U.S.C. § 119(a) on Patent Application No. 10-2004-0071009 filed in Korea on Sep. 6, 2004, the entire contents of which are hereby incorporated by reference.

### BACKGROUND OF THE INVENTION

1. Field of the Invention

The present invention relates to a Plasma Display Panel (PDP).

2. Background of the Related Art

Generally, a conventional PDP is adapted to display images including characters or graphics by emitting phosphors with UV rays of 147 nm generated during the discharge of an inert mixed gas of He+Xe or Ne+Xe.

FIG. 1 is a perspective view illustrating the structure of a common three-electrode AC surface discharge type PDP.

Referring to FIG. 1, the three-electrode AC surface discharge type PDP 100 includes a scan/sustain electrode 11 and a common sustain electrode 12 formed on an upper substrate 10, and an address electrode 22 formed on a lower substrate 20.

Each of the scan/sustain electrode 11 and the common sustain electrode 12 has transparent electrodes 11a, and 12a and bus electrodes 11b, 12b. The transparent electrodes 11a, 12a are formed using Indium-Tin-Oxide (ITO). The bus electrodes 11b, 12b are formed using metal capable of reducing resistance. An upper dielectric layer 13a and a protection film 14 are sequentially laminated on the upper substrate 10 having the scan/sustain electrode 11 and the common sustain electrode 12 formed thereon. On the upper dielectric layer 13a are accumulated wall charges generated during the discharge of plasma. The protection film 14 serves to prevent damage to the upper dielectric layer 13a due to sputtering generated during the discharge of plasma, and enhance emission efficiency of secondary electrons. The protection film 14 is generally formed of magnesium oxide (MgO).

A lower dielectric layer 13b and barrier ribs 21 are formed on the lower substrate 20 where the address electrode 22 is formed. A phosphor layer 23 is coated on a surface of the lower dielectric layer 13b and the barrier ribs 21. The address electrode 22 crosses the scan/sustain electrode 11 and the common sustain electrode 12. The barrier ribs 21 are parallel to the address electrode 22, and serve to prevent UV rays and a visible ray generated by discharge from leaking to adjacent discharge cells. The phosphor layer 23 is excited by UV rays generated during the discharge of plasma to generate any of the red, green and blue visible rays. An inert mixed gas, such as He+Xe or Ne+Xe, for discharging is injected into discharge spaces of the discharge cells, which are provided between the upper/lower substrates 10, 20 and the barrier ribs 21.

FIGS. 2a and 2b are views showing a discharge cell structure of the conventional PDP. FIG. 2a shows the discharge cell structure in which the barrier ribs have a stripe type and FIG. 2b shows the discharge cell structure in which the barrier ribs have a well type.

Referring to FIGS. 2a and 2b, sub-pixels 101a, 101b and 101c of the conventional PDP having the discharge cell structure described above include the barrier ribs 21 formed thereon for separating phosphors emitting R, G and B colors. In these sub-pixels 101a, 101b and 101c, the R, G and B sub-pixels gather to form a unit pixel 101 on the basis of the barrier ribs 21. Each unit pixel is also disposed in the same shape as an adjacent unit pixel on the basis of the barrier ribs 21, thus representing images.

In the PDP having the above-described discharge cell structure, the barrier ribs serve to prevent electrical and optical crosstalk between sub-pixels or unit pixels. The barrier ribs are the most important element to control characteristics such as display quality and emission efficiency.

The barrier ribs formed in the conventional PDP will be described in more detail. The width “a” of the barrier ribs partitioning the unit pixel and the width “b” of the barrier ribs bordering the R, G and B sub-pixels constituting the unit pixel are the same. This structure causes a problem in that a mixed color characteristic depending on the color of an adjacent unit pixel is inaccurate in a PDP in which respective unit pixels are emitted and combined to represent images. That is, since the width of barrier ribs formed between sub-pixels and the width of barrier ribs formed between unit pixels are the same, a mixed color characteristic of a unique color of a unit pixel is degraded due to the color of an adjacent unit pixel when the PDP is driven.

There is also a phenomenon that the screen in a conventional PDP is blurred depending on the phosphor color of sub-pixels, which are located in adjacent unit pixels, of sub-pixels constituting the conventional unit pixel. This phenomenon is more profound as the resolution of the PDP increases. There is also a problem in that a contrast characteristic is in adequate since the barrier ribs of the conventional PDP are highly reflective.

### SUMMARY OF THE INVENTION

Accordingly, the present invention has been made to solve the above-mentioned problems occurring in the prior art, and it is an object of the present invention to provide a PDP in which the mixed color property that is visually seen by a person can be improved by improving pixel cells and barrier ribs, as well as sharpness can be improved by reducing a phenomenon where the PDP screen is blurred.

Another object of the present invention is a PDP in which the brightness and the contrast characteristics can be improved through improvements of unit pixels and barrier ribs.

A plasma display panel according to a first embodiment of the present invention includes first barrier ribs for partitioning a plurality of sub-pixels, and second barrier ribs for partitioning adjacent unit pixels with the plurality of sub-pixels forming one unit pixel. In this case, the width of the second barrier ribs partitioning the unit pixels is wider than that of the first barrier ribs partitioning the plurality of sub-pixels, and a sub-pixel located at the center among the plurality of sub-pixels is a blue sub-pixel.

A black material layer may be formed on either the first barrier ribs or the second barrier ribs.

A plasma display panel according to a second embodiment of the present invention includes a first substrate having first barrier ribs for partitioning a plurality of sub-pixels, and second barrier ribs for partitioning adjacent unit pixels with the plurality of sub-pixels forming one unit pixel, the width of the second barrier ribs being wider than that of the first barrier ribs; and a second substrate having a black matrix formed corresponding to the second barrier ribs. A sub-pixel located at the center among the plurality of sub-pixels is a blue sub-pixel.

Either the first barrier ribs or the second barrier ribs may include a white material.

A plasma display panel according to a third embodiment of the present invention includes first barrier ribs for partitioning a plurality of sub-pixels, and second barrier ribs for partitioning adjacent unit pixels with the plurality of sub-pixels forming one unit pixel, the width of the second barrier ribs being wider than that of the first barrier ribs. In this case, both the first barrier ribs and the second barrier ribs are formed of a black material, and a sub-pixel located at the center among the plurality of sub-pixels is a blue sub-pixel.

The width of the second barrier ribs may be 1.2 to 12 times that of the first barrier ribs.

A discharge cell structure constructed of the first barrier ribs and the second barrier ribs may be any one of a stripe type, a well type, a delta type a honeycomb type.

### BRIEF DESCRIPTION OF THE DRAWINGS

Further objects and advantages of the invention can be more fully understood from the following detailed description taken in conjunction with the accompanying drawings in which:

FIG. 1 is a perspective view illustrating the structure of a conventional three-electrode AC surface discharge type PDP;

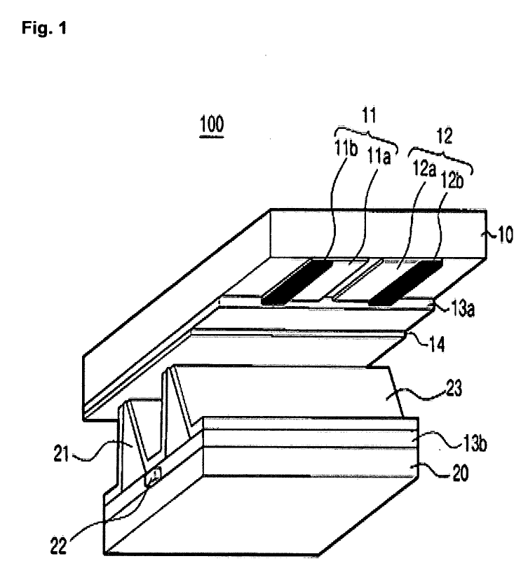

FIGS. 2a and 2b are views showing a discharge cell structure of the conventional PDP;

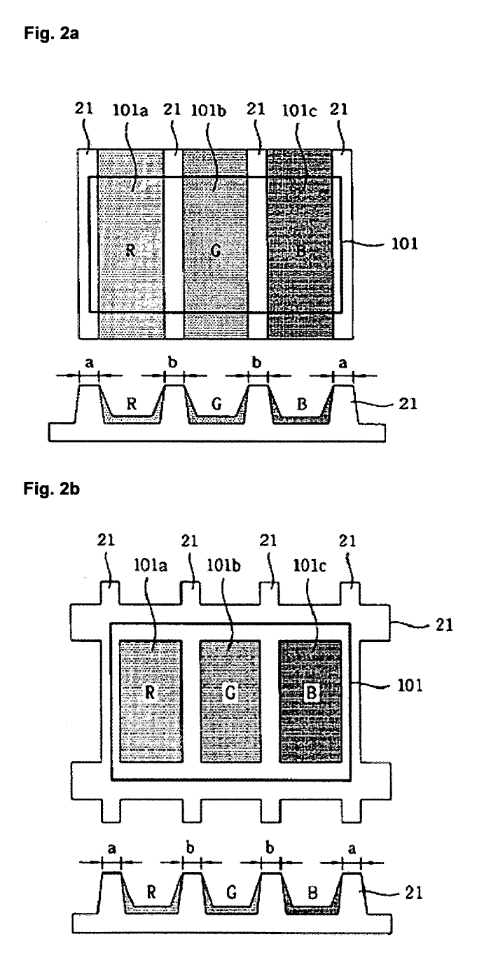

FIGS. 3a and 3b are views showing a barrier rib structure depending on a discharge cell structure of a PDP according to a first embodiment of the present invention;

FIGS. 4a and 4b are views showing a barrier rib structure and a black matrix structure depending on depending on a discharge cell structure of a PDP according to a second embodiment of the present invention; and

FIGS. 5a and 5b are views showing a barrier rib structure depending on a discharge cell structure of a PDP according to a third embodiment of the present invention.

### DETAILED DESCRIPTION OF THE PREFERRED EMBODIMENT

The present invention will now be described in detail in connection with preferred embodiments with reference to the accompanying drawings.

### First Embodiment

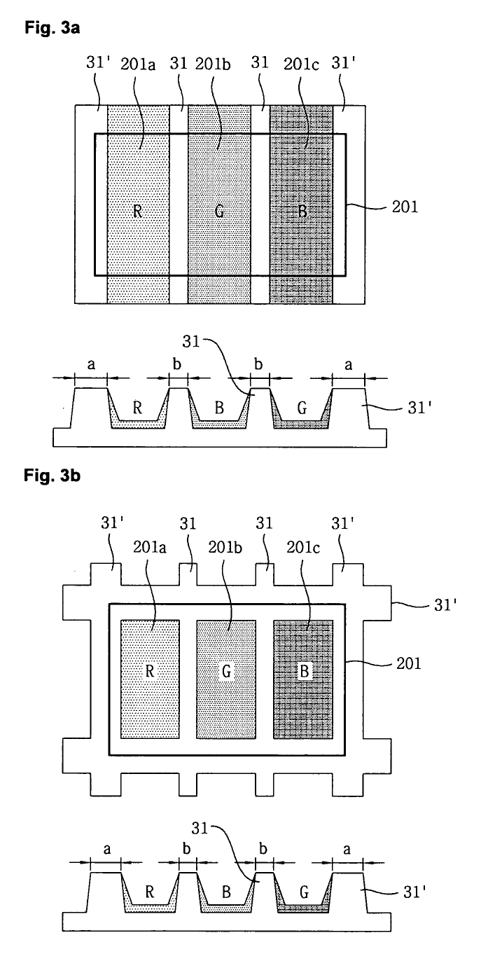

FIGS. 3a and 3b are views showing a barrier rib structure depending on the discharge cell structure of a PDP according to a first embodiment of the present invention. That is, FIG. 3a shows the barrier rib structure when the discharge cell structure is the stripe type according to the present invention. FIG. 3b shows the barrier rib structure when the discharge cell structure is the well type.

As shown in FIGS. 3a and 3b, in barrier ribs of the PDP according to the present invention, first barrier ribs 31 for partitioning red (R), blue (B) and green (G) sub-pixels 201a, 201b and 201c, and second barrier ribs 31′ for partitioning adjacent unit pixels with the red (R), blue (B) and green (G) sub-pixels forming one unit pixel 201 are formed in a rear substrate. At this time, assuming that the width of the first barrier ribs 31 for partitioning the red (R), blue (B) and green (G) sub-pixels 201a, 201b and 201c is “b” and the second barrier ribs 31′ partitioning the unit pixel 201 is “a”, the width “a” of the second barrier ribs is wider than the width “b” of the first barrier ribs. That is, the width “a” of the second barrier ribs 31′ partitioning the unit pixels is wider than the width “b” of the first barrier ribs 31 partitioning the sub-pixels.

If the width “a” of the second barrier ribs 31′ is wider than the width of the first barrier ribs, a mixed color among adjacent unit pixels prevented. If the width “a” of the second barrier ribs 31′ is wider than the width “b” of the first barrier ribs 31 over a predetermined width, however, implement sufficient resolution becomes difficult. Therefore, the width “a” of the second barrier ribs 31′ can be 1.2 to 12 times the width “b” of the first barrier ribs 31.

In the structure of sub-pixels constituting a unit pixel, the blue (B) sub-pixel is located at the center of the unit pixel to improve the sharpness of the screen when the PDP is driven. The positions of the red (R) and green (G) sub-pixels, which are the remaining sub-pixels excepting for the blue (B) sub-pixel at the center, can be interchanged.

FIGS. 3a and 3b show that the sub-pixels constituting the unit pixel are red (R), blue (B) and green (G). To increase the color purity, however, the unit pixel can comprise of four or more kinds of sub-pixels such as red (R), blue (B), yellow (Y) and green (G), or red (R), blue (B), white (W) and green (G). Even in this case, the blue (B) sub-pixel is located at the center of the unit pixel.

Though not shown in the drawings, a black material layer can be formed on either the first barrier ribs 31 or the second barrier ribs 31′ to improve contrast.

The shape of the barrier ribs can be applied to not only the discharge cell structure of the stripe type and the well type, which are shown in the present invention, but also the discharge cell structure of a delta type or a honeycomb type.

For example, when the discharge cell structure is the stripe type, the first barrier ribs are formed to divide the red and the blue sub-pixels, and the blue and the green sub-pixels. The second barrier ribs are formed between sub-pixels of adjacent unit pixels of each the red sub-pixel and the green sub-pixel. When the discharge cell structure has the well type, the first barrier ribs are formed to divide the red and the blue sub-pixels, and the blue and the green sub-pixels. The second barrier ribs are formed to divide longitudinal barrier ribs formed between sub-pixels of adjacent unit pixels of each of the red sub-pixel and the green sub-pixel, and the unit pixels located at the top and the bottom.

These barrier ribs can be fabricated using any one of sandblasting method, a screen-printing method, an additive method and a photosensitive paste method.

As described above, in the PDP having the barrier rib structure according to a first embodiment of the present invention, the color of the unit pixel, which is combined through emission of a plurality of sub-pixels, is spatially far apart from the color of adjacent unit pixels, thus improving the mixed color property that is visually seen by a person. More particularly, the blue sub-pixel that degrades the color temperature is located at the center of the unit pixel. It is thus possible to prevent the screen from being blurred when a PDP is driven.

### Second Embodiment

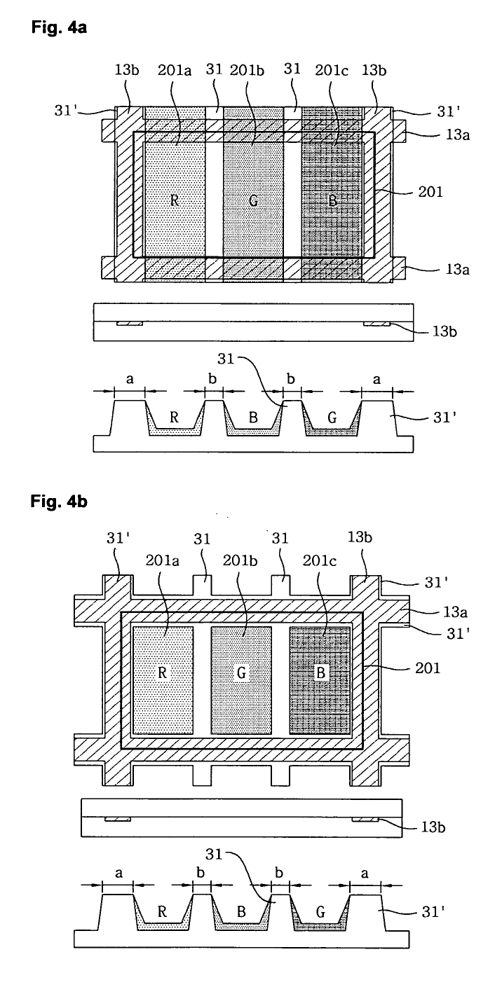

FIGS. 4a and 4b are views showing a barrier rib structure and a black matrix structure depending on the discharge cell structure of a PDP according to the second embodiment of the present invention. FIG. 4a shows the barrier rib structure and the black matrix structure when the discharge cell structure is of the stripe type according to the present invention. FIG. 4b shows the barrier rib structure and the black matrix structure when the discharge cell structure is of the well type according to the present invention.

The barrier rib structure of the PDP according to the present invention shown in FIGS. 4a and 4b has the same position as that of the barrier rib structure and the blue sub-pixels according to the first embodiment. Description thereof will be omitted. A black matrix having a predetermined pattern is formed in a front substrate of the PDP according to the present invention. The black matrix 13a is formed in the front substrate of a location corresponding to the second barrier ribs 31′ regardless of whether the discharge cell structure is the stripe type or the well type. In the case of the stripe type, however, the black matrix can be formed in a direction perpendicular to the first barrier ribs 31 and the second barrier ribs 31′, as shown in the drawings. This black matrix is formed at a location that divides upper and lower discharge cells. To compensate for a reduction of the brightness of the PDP due to the black matrix formed in the front substrate, either the first barrier ribs or the second barrier ribs can include a white material.

The black matrix can be formed in the front substrate in a location corresponding to the first barrier ribs 31 that divides respective sub-pixels when a contrast characteristic depending on optical transmittance of the front substrate is lowered. Furthermore, though not shown in the drawings, a black material layer for improving a contrast characteristic can be formed on either the first barrier ribs 31 or the second barrier ribs 31′.

This black matrix can be formed by a screen printing method using a paste of a black matrix material. The paste can be a metallic compound such as chrome (Cr) or a non-metallic compound. If the black matrix material is a metal compound, however, contrast can be improved through reduced reflectance. However, when cells are discharged by applying a voltage to a number of electrodes formed in the front substrate, the black matrix is electrified due to insulation breakage of a dielectric material covering the electrodes. Thus, a problem arises because an erroneous discharge is generated in PDP cells. Accordingly, Non-metal should be used.

As described above, the PDP having the barrier rib structure and the black matrix structure according to a second embodiment of the present invention can improve the mixed color property through emission of phosphors from each unit pixel and can also lower reflectance depending on external light and internal transmitting light, thus improving contrast. In addition, in the same manner as the first embodiment, it is possible to prevent the screen from being blurred when the PDP is driven.

### Third Embodiment

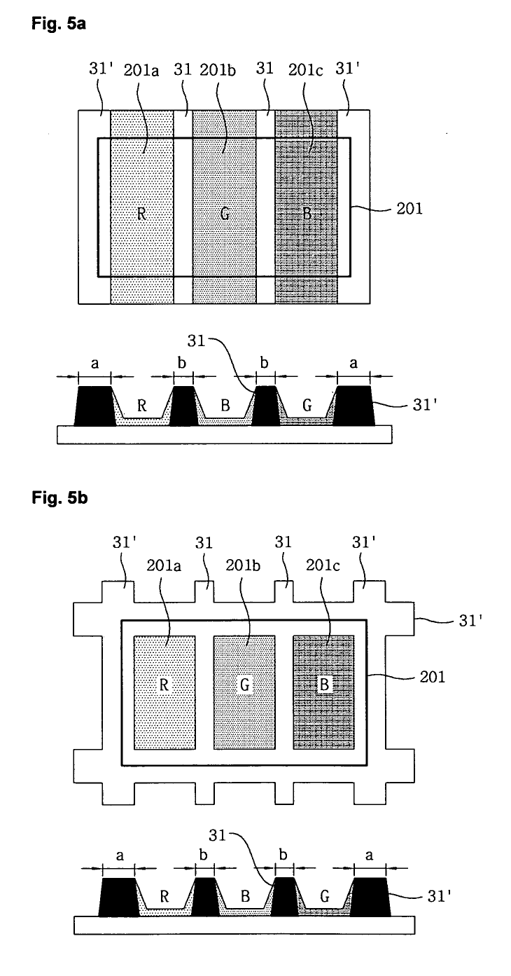

FIGS. 5a and 5b are views showing a barrier rib structure depending on the discharge cell structure of a PDP according to the third embodiment of the present invention. FIG. 5a shows the barrier rib structure when the discharge cell structure is of the stripe type according to the present invention. FIG. 5b shows the barrier rib structure when the discharge cell structure is of the well type according to the present invention.

The barrier rib structure of the PDP according to the present invention shown in FIGS. 5a and 5b also has the same position as that of the barrier rib structure and the blue sub-pixels according to the first embodiment. Description thereof will be omitted. However, barrier ribs are all formed of a black material.

As described above, the PDP having the barrier rib structure according to a third embodiment of the present invention can improve the mixed color property due to emission of phosphors from each unit pixel and can also lower reflectance depending on external light and internal transmitting light, thus improving contrast. In addition, in the same manner as the first embodiment, it is possible to prevent the screen from being blurred when a PDP is driven.

As described above, the present invention has effects in that a mixed color with adjacent unit pixels when a PDP is driven can be prevented and a contrast characteristic can be improved.

The present invention is also advantageous in that the sharpness of the screen can be improved by preventing the screen from being blurred when the PDP is driven.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A plasma display panel, comprising:
first barrier ribs for partitioning a plurality of sub-pixels; and
second barrier ribs for partitioning adjacent unit pixels with the plurality of sub-pixels forming one unit pixel,
wherein the width of the second barrier ribs partitioning the unit pixels is wider than the width of the first barrier ribs partitioning the plurality of sub-pixels, and a sub-pixel located at the center among the plurality of sub-pixels is a blue sub-pixel.

2. The plasma display panel as claimed in claim 1, wherein a black material layer is formed on either the first barrier ribs or the second barrier ribs.

3. The plasma display panel as claimed in claim 1, wherein the width of the second barrier ribs is 1.2 to 12 times the width of the first barrier ribs.

4. The plasma display panel as claimed in claim 1, wherein a discharge cell structure constructed of the first barrier ribs and the second barrier ribs is any one of a stripe type, a well type, a delta type and a honeycomb type.

5. The plasma display panel as claimed in claim 1, wherein the unit pixel consists of a plurality of sub-pixels arranged in the order of red, blue and green.

6. The plasma display panel as claimed in claim 5, wherein the sub-pixels are divided by stripe type barrier ribs,
the first barrier ribs are stripe barrier ribs for dividing red and blue sub-pixels, and blue and green sub-pixels, and
the second barrier ribs are stripe barrier ribs formed between sub-pixels of adjacent unit pixels of each of the red sub-pixel and the green sub-pixel.

7. The plasma display panel as claimed in claim 5, wherein the sub-pixels are divided by lattice type barrier ribs,
the first barrier ribs are longitudinal barrier ribs for dividing red and blue sub-pixels, and blue and green sub-pixels, and
the second barrier ribs are longitudinal barrier ribs formed between sub-pixels of adjacent unit pixels of each of the red sub-pixel and the green sub-pixel, and lateral barrier ribs divided from the unit pixels located at the top and bottom of the unit pixel.

8. A plasma display panel, comprising:
a rear substrate having first barrier ribs for partitioning a plurality of sub-pixels, and second barrier ribs for partitioning adjacent unit pixels with the plurality of sub-pixels forming one unit pixel, the width of the second barrier ribs being wider than that of the first barrier ribs; and
a front substrate having a black matrix,
wherein a sub-pixel located at the center among the plurality of sub-pixels is a blue sub-pixel.

9. The plasma display panel as claimed in claim 8, wherein either the first barrier ribs or the second barrier ribs includes a white material.

10. The plasma display panel as claimed in claim 8, wherein a black layer is formed on the first barrier ribs and the second barrier ribs.

11. The plasma display panel as claimed in claim 8, wherein the black matrix corresponds to the second barrier ribs.

12. The plasma display panel as claimed in claim 8, wherein the width of the second barrier ribs is 1.2 to 12 times that of the first barrier ribs.

13. The plasma display panel as claimed in claim 8, wherein a discharge cell structure constructed of the first barrier ribs and the second barrier ribs is any one of a stripe type, a well type, a delta type and a honeycomb type.

14. A plasma display panel, comprising:
first barrier ribs for partitioning a plurality of sub-pixels; and
second barrier ribs for partitioning adjacent unit pixels with the plurality of sub-pixels forming one unit pixel, the width of the second barrier ribs being wider than that of the first barrier ribs,
where in both the first barrier ribs and the second barrier ribs are formed of a black material, and a sub-pixel located at the center among the plurality of sub-pixels is a blue sub-pixel.

15. The plasma display panel as claimed in claim 14, wherein the width of the second barrier ribs is 1.2 to 12 times that of the first barrier ribs.

16. The plasma display panel as claimed in claim 14, wherein a discharge cell structure constructed of the first barrier ribs and the second barrier ribs is any one of a stripe type, a well type, a delta type and a honeycomb type.
